(19) United States
(12) Patent Application Publication
(10) Pub. No.: US 2010/0134818 A1
(43) Pub. Date: Jun. 3, 2010

(54) DATA PROCESSING APPARATUS, PRINTER NETWORK SYSTEM, DATA PROCESSING METHOD, AND COMPUTER-READABLE RECORDING MEDIUM THEREOF

(76) Inventors: Katsushi MINAMIZONO, Kanagawa (JP); Yuka MINAMIZONO, Kanagawa (JP); Akira KOHNO, Tokyo (JP); Katsunori SUZUKI, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/627,446

(22) Filed: Nov. 30, 2009

(30) Foreign Application Priority Data
Dec. 2, 2008 (JP) 2008-307495
Oct. 1, 2009 (JP) 2009-229846

(51) Int. Cl. G06F 3/12

(52) U.S. Cl. 358/1.13; 358/1.15

(57) ABSTRACT

A data processing apparatus is disclosed, including: a virtual printer driver and a plurality of remote drivers. The virtual printer driver receives a print request through the network, creates an intermediate file as a page image from print data corresponding to the print request, has a remote driver corresponding to output destination printer information corresponding to the client computer or a user of the client computer create output data for a remote printer, and has the remote printer output the output data. The remote driver is called by the virtual printer driver, creates the output data including RAW data from the intermediate file, and has the remote printer selected through the network print out the output data.

### BACKGROUND OF THE INVENTION

1. Field of the Invention

The present invention is related to a data processing technology for distributed printing, and in particular, a data processing apparatus, a printer network system, a data processing method, and a computer-readable recording medium thereof.

2. Description of the Related Art

Recently, along with popularization of a network technology, in an office environment, a personal computer is connected to an image forming apparatus, which is a so-called MFP (Multi-Function Peripherals) or collectively called a page printer, and mostly sends data to be printed to the image forming apparatus being remotely connected.

Also, a print server may be connected to a network. In a case in which the print server is connected, the personal computer connects [symbol] the print server when printing is conducted, and the printing is conducted by a page printer indicated as an output destination through the print server. In another case, the personal computer may be connected to a local printer via a USB (Universal Serial Bus) or a wireless USB.

Under this office environment, the personal computer may be connected to a plurality of image forming apparatuses. If an output does not have a problem with a security level or is irrelevant to personal information, there is no problem even if a user of the personal computer outputs to an unintended output destination. However, the personal computer creates various types of documents by processing various data.

Consequently, there may be a problem in that a document requiring high security, a document including personal information of a high level, and the like are unintentionally output by an image forming apparatus being easily accessed by a third party. Moreover, recently, Internet facsimile has become popular, in which a facsimile transmission can be used by using a print wizard of an application. In this environment, a user of the application may transmit a document being for internal use only in a company to unintended persons by accident. This case may cause serious damage to the company.

Various technologies for controlling an output destination of printed material are well-known. For example, Japanese Laid-open Patent Application No. 2003-140867 discloses an information processing apparatus which can change the image forming apparatus to print out in response to a circumstance of the image forming apparatus being connected to the network. Japanese Laid-open Patent Application No. 2004-282273 discloses a department management control system which restricts or changes an output process conducted by other departments in the image forming apparatus being connected through the network.

Furthermore, Japanese Patent No. 3726634 discloses a technology to print out print data generated by an application program by distributing to a plurality of printers. The technology disclosed in Japanese Patent No. 3726634 makes it possible to conduct parallel printing without repeatedly setting output distributions by a user in a case of conducting the parallel printing for a plurality of volumes of the same print data. In this technology, a virtual printer driver is formed, and a virtual printer indicates a printer group with respect to a plurality of printers to conduct the parallel printing.

Japanese Laid-open Patent Application No. 2003-140867 discloses an information processing apparatus which changes the output destination in response to the circumstance of the image forming apparatus such as a print load, a failure, and the like. However, in a case in that the image forming apparatus is in a regular operating state, for example, when this image forming apparatus is wrongly selected, a document is unexpectedly printed out from this image forming apparatus. Since a current personal computer conducts a process at sufficiently high speed, if the image forming apparatus is wrongly selected, it is virtually impossible to completely cancel the entire output of printing.

Moreover, in the department management control system disclosed in Japanese Laid-open Patent Application No. 2004-282273, a correspondence table is prepared for the image forming apparatus to conduct output control with respect to a department, and print output control is performed by identifying the department from a print request. Japanese Laid-open Patent Application No. 2004-282273 simply discloses to conduct the print control in a case where a plurality of personal computers use a single image forming apparatus. However, in a case where a single personal computer manages a plurality of image forming apparatuses, the department management control system disclosed in Japanese Laid-open Patent Application No. 2004-282273 cannot control access from the personal computer.

Furthermore, the technology disclosed in Japanese Patent No. 3726634 makes it possible to conduct the parallel printing by changing a printer when a plurality of volumes for the same print data are printed out. However, the technology cannot with certainty indicate the output destination to print out, by selecting a printer indicated from a plurality of printers.

Moreover, recently, a client having a minimum function alone, a so-called thin client, has been noticed for its cost performance. The thin client has an essential client application, and conducts a transaction by utilizing a server program in a practical process. The above-described technologies cannot properly print out without sending print data to unintended output destinations when receiving a print request from the thin client.

Furthermore, the server program can reduce costs for modifying an application to be lower than a mainframe computer. However, if a large amount of modification is required for the server program to control the output destination, an advantage of introducing a printer network is lost. That is, in addition to the workload of building the printer network, the user is required to modify the server program. Moreover, when the above-described software platform is modified and the printer network is installed, it is required to shut down the business computer system in order to reinstall the server program. Thus, an unwanted expense occurs in a business. Accordingly, it is difficult to conduct output destination management without any problem, instead of greatly modifying an application configuration of the server program.

### SUMMARY OF THE INVENTION

The present invention solves or reduces one or more of the above problems.

In an aspect of this disclosure, there is provided a data processing apparatus for managing print outputs for one or more client computers through a network, including: a virtual printer driver configured to receive a print request through the network, to create an intermediate file as a page image from print data corresponding to the print request, to have a remote driver corresponding to output destination printer information corresponding to the client computer or a user of the client computer create output data for a remote printer, and to cause the remote printer to output the output data; and a plurality of remote drivers each of which is configured to be called by the virtual printer driver, to create the output data including RAW data from the intermediate file, and to cause the remote printer selected through the network to print out the output data.

In other aspects of this disclosure, there may be provided a printer network system, a data processing method, and a computer-readable recording medium thereof.

### BRIEF DESCRIPTION OF THE DRAWINGS

In the following, embodiments of the present invention will be described with reference to the accompanying drawings.

FIG. 1 is a diagram illustrating a printer network including a data processing apparatus according to a first embodiment of the present invention;

FIG. 2 is a diagram illustrating a function block of the data processing apparatus according to the first embodiment of the present invention;

FIG. 3 is a flowchart of a process conducted by the data processing apparatus according to the first embodiment of the present invention;

FIG. 4 is a diagram illustrating examples of correspondence tables maintained by a destination control part according to the first embodiment of the present invention;

FIG. 5 is a diagram illustrating an example of a printer information list in which configuration information concerning a configuration of a remote printer used by an output data sending part is registered, according to the first embodiment of the present invention;

FIG. 6 is a flowchart of a process conducted by the output data sending part according to the first embodiment of the present invention;

FIG. 7 is a flowchart of a process conducted by a destination control part according to the first embodiment of the present invention;

FIG. 8 is a flowchart of a modification of the process conducted by the destination control part according to the first embodiment of the present invention;

FIG. 9 is a diagram illustrating an example of a print condition management table according to the first embodiment of the present invention;

FIG. 10 is a diagram illustrating a printer network according to a second embodiment of the present invention;

FIG. 11 is a diagram illustrating a function block of a data processing server according to the second embodiment of the present invention;

FIG. 12 is a flowchart of a destination control process conducted by the data processing server according to the second embodiment of the present invention; and

FIG. 13 is a diagram illustrating another function block of the data processing server according to the second embodiment of the present invention.

### DESCRIPTION OF THE PREFERRED EMBODIMENTS

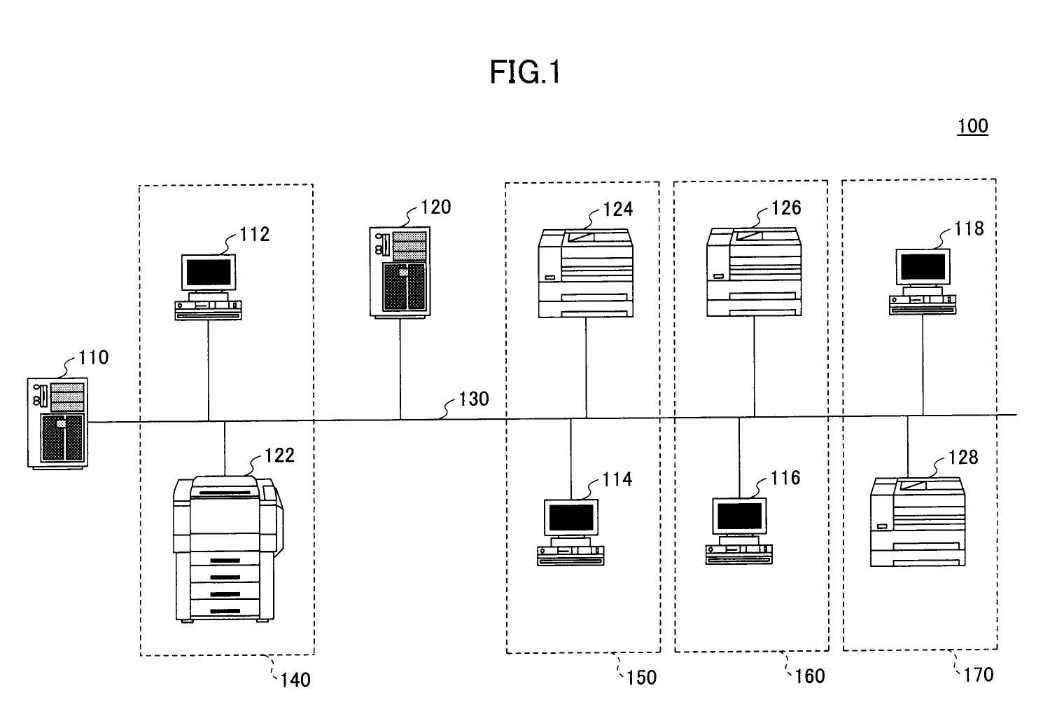

In the following, the present invention will be described with reference to the accompanying drawings. The present invention is not limited to embodiments described in the following. FIG. 1 illustrates a printer network system 100 including a data processing apparatus 110 according to a first embodiment of the present invention. In the printer network system 100, a plurality of client computers (hereinafter, simply referred as clients) 112, 114, 116, and 118 installed in an office or the like connect to a network 130. In addition to the data processing apparatus 110, a print server 120 and remote printers such as an MFP (Multi-Function Peripherals) 122, laser printers 124 and 126, an inkjet printer 128, and the like which are given as examples, are connected to the network 130. In this embodiment, hereinafter, the MFP 122, and the printers 124, 126, and 128 are collectively called the remote printers 122, 124, 126, and 128.

In an embodiment illustrated in FIG. 1, the data processing apparatus 110 acquires a print request and print data corresponding to the print request. The data processing apparatus 110 determines remote printers assigned to the clients 112, 114, 116, and 118, and creates RAW data corresponding to the print data with respect to the remote printers assigned to the clients 112, 114, 116, and 118. For example, an addition process of a PDL (Page Description Language) command is conducted. Then, the created RAW data are set as output data and sent to the indicated remote printers 122, 124, 126, and 128 through the print server 120. As a result, print processes are performed by the remote printers corresponding to the clients 112, 114, 116, and 118.

When the remote printers are assigned to the clients 112, 114, 116, and 118, as an identification value of hardware of the client, an IP address, a MAC address (Media Access Control Address), a computer name given to the client, a login name of a user, or the like can be used for each of clients 112, 114, 116, and 118. In the embodiment, these values are generically called unique identification values.

In the embodiment, the data processing apparatus 110 is implemented as a server apparatus, and includes a CPU (Central Processing Unit) forming a single core or a multi-core, a ROM (Read Only Memory), a RAM (Random Access Memory) for providing an execution space, a hard disk unit, and the like. Under control of an operating system (OS) such as Windows™ 200X server, UNIX™, LINUX™, Solaris™, or the like, an output destination of the print data is controlled. Also, between the data processing apparatus 110 and each of the clients 112, 114, 116, and 118, transactions can be conducted by using proper remote connection protocols.

Various aspects are considered to assign the remote printers 122, 124, 126, and 128 to the clients 112, 114, 116, and 118. For example, in a specific embodiment, the remote printers 122, 124, 126, and 128 can be assigned as the output destinations for corresponding unique identification values identifying the client or a user. In another embodiment, a client group or a user group may be set, and a specific remote printer is assigned for each group unit. In the embodiment illustrated in FIG. 1, the client 112 and the remote printer 122 form a base 140. Regarding other clients 114, 116, and 118, bases 150, 160, and 170 are formed by corresponding to the printers 124, 126, and 128. A plurality of the clients may be in each of the bases 140, 150, 160, and 170. In the same manner, a plurality of remote printers may be in each of the bases 140, 150, 160, and 170.

The print server 120 manages each of the remote printers 122, 124, 126, and 128, and receives a print request which is sent from the data processing apparatus 110 based on a print request sent from each of the clients 112, 114, 116, and 118. The printer server 120 sends the print data with respect to one of the remote printers 122, 124, 126, and 128 which is defined as a print destination in the received print request, and has the remote printer of the print destination execute a print job. In detail, the print server 120 includes printer drivers corresponding to the remote printers 122, 124, 126, and 128. The printer driver corresponding to a remote printer indicated as the print destination in the print request controls receiving the print request from the data processing apparatus 110 and sending the print data to the remote printer.

In a preferred embodiment of the print server 120, the print server 120 is implemented as a server apparatus, and a hardware configuration and an OS configuration can be the same as those of the data processing apparatus 110. It should be noted that the print server 120 is not required to be always implemented as the server apparatus. The print server 120 can be realized by implementing a print server application in a personal computer.

The clients 112, 114, 116, and 118 have the same configuration. The clients 112, 114, 116, and 118 may be fat client apparatuses. For example, each of clients 112, 114, 116, and 118 may be a personal computer or a workstation which implements an application program and completes various processes. In a case in which the clients 112, 114, 116, and 118 are fat clients, each of the clients 112, 114, 116, and 118 includes a CPU of a single core or a multi-core, and includes a RAM, a ROM, a hard disk unit, and a network interface card (NIC). Under a proper OS such as Windows™, UNIX™, LINUX™, Mac OS™, or the like, the remote printers 122, 124, 126, and 128 are requested to perform print processes.

Each of the clients 112, 114, 116, and 118 being the fat clients reads out the application program and data from the hard disk unit into the RAM. The CPU executes the application program, and generates the print data to be printed as electronic data such as a document, an image, a multi-medium, and a compositive combination thereof.

Also, in another embodiment, the clients 112, 114, 116, and 118 may be the thin clients. Each of the thin clients simply includes functions which issue a service request to, receive a process result from, and request a print output from the data processing apparatus 110 such as a network connection module, a user authentication function, and a session generation module. In a case in which the clients 112, 114, 116, and 118 are the thin clients, when each of the clients 112, 114, 116, and 118 ends a process by the application, a print request is issued to the data processing apparatus 110.

The data processing apparatus 110 sends print data created in response to the print request of the thin client to a virtual printer driver 230, and conducts the print process. Details of the virtual printer driver 230 will be described later.

Each of the page printers 124 and 126 of the remote printers 122, 124, 126, and 128 includes a network interface card (NIC) to receive the print data from the print server 120 through the network 130, and to conduct a print job. The MFP 122 may be the remote printer connected to the network 130 with a network board, and may include a function of a print server in addition to a print function.

The network 130 includes a wireless network being compliant with a standard of Ethernet such as 1000 Base-TX™, an optical network, IEEE 802.11, or the like. The network 130 conducts mutual packet communications in accordance with a frame or TCP/IP. The network 130 may include a wide area network such as the Internet under a secure environment with a VPN (Virtual Private Network) or the like.

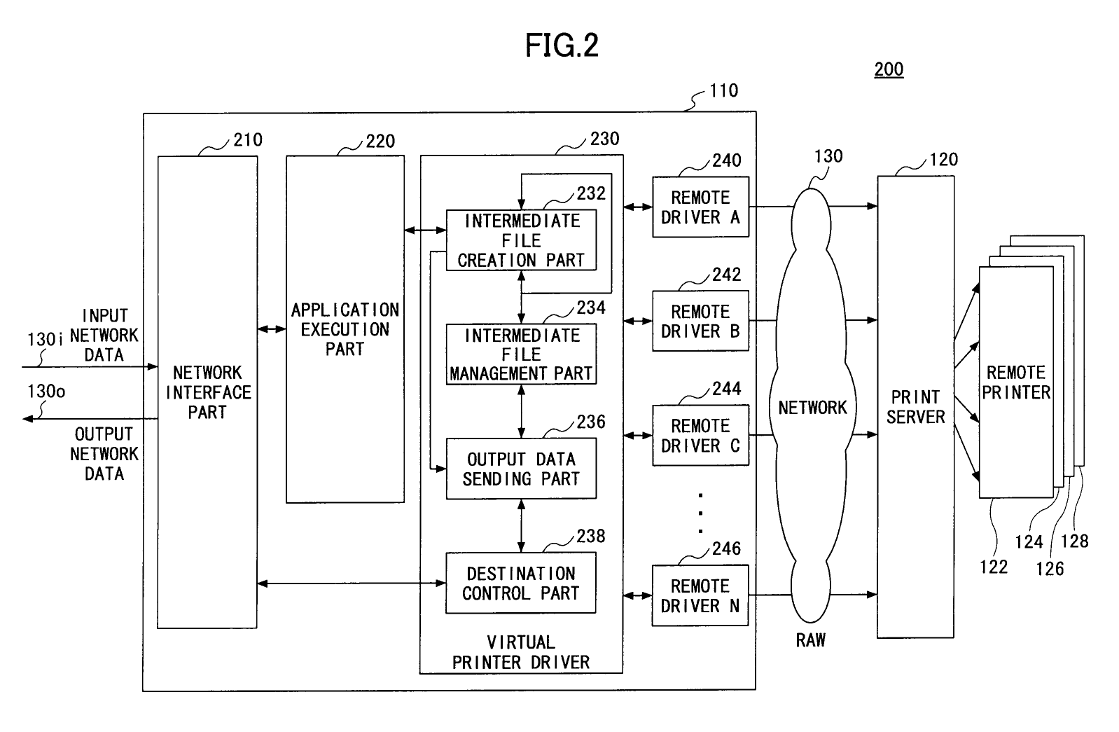

FIG. 2 illustrates a function block 200 of the data processing apparatus 110 according to the embodiment. As illustrated in FIG. 2, the data processing apparatus 110 includes a plurality of function parts. The plurality of function parts are be realized by the CPU which reads programs concerning the function parts into the RAM or the like and executes the programs.

As illustrated in FIG. 2, the data processing apparatus 110 includes a network interface part 210 and an application execution part 220. The network interface part 210 receives data (as input network data 130i) in accordance with TCP/IP through the network 130, and outputs a process result (as output network data 130o) of the application execution part 220 through the network 130. The application execution part 220 executes a process corresponding to an instruction of each of the clients 112, 114, 116, and 118 by using the received process request and data, and creates an execution result. For example, the application execution part 220 responds to the print request from each of the clients 112, 114, 116, and 118, creates the print data from the execution result, and has an indicated remote printer print out the print data.

The data processing apparatus 110 further includes the virtual printer driver 230, and remote driver 240, 242, 244, and 246 corresponding to the remote printers 122, 124, 126, and 128 in order to create RAW data specific to a each device of the remote printers 122, 124, 126, and 128. The virtual printer driver 230 is activated in response to a call from the application execution part 220. The virtual printer driver 230 acquires information concerning the clients 112, 114, 116, and 118 issuing the print request, a user name, or specific information which the print data itself includes. For example, the virtual printer driver 230 acquires a unique identification value such as text, image data, or the like of a price table, a medical service fee, an order form, or the like. Then, the virtual printer driver 230 identifies the remote printer assigned to the unique identification value. After that, the virtual printer driver 230 calls one of the remote drivers 240, 242, and 246 which corresponds to one of the remote printers 122, 124, 126, and 128 which is identified, and creates the RAW data specific to the device of the identified remote printer to print out.

The print server 120 downloads the remote drivers 240, 242, 244, and 246 from the print server 120 to the data processing apparatus 110 based on each of printer drivers included in respective remote printers 122, 124, 126, and 128. Each of the remote drivers 240, 242, 244, and 246 is called by the virtual printer driver 230, and executes creation of the RAW data. In the created RAW data, a page control language command such as a PDL command or a printer control language command are appropriately added, and the output data are generated. The generated output data are sent to the printer driver corresponding to the remote driver in the print server 120 through a spooler and a port monitor of the corresponding one of the remote drivers 240, 242, 244, and 246. The output data are sent to the indicated remote printer through the network 130 by the printer driver of the print server 120. A print out is conducted at the indicated remote printer.

In order to perform the above-described processes, in this embodiment, the virtual printer driver 230 includes an intermediate file creation part 232, an intermediate file management part 234, an output data sending part 236, and a destination control part 238. The intermediate file creation part 232 processes an execution result created by the application execution part 220, and creates an intermediate file of a page image in a format such as bitmap, EMF (Enhanced Meta-data Format), GIF, TIFF, JPEG, JPEG 2000, or the like, from text data and image data. The intermediate creation part 232 repeats a process of creating the intermediate files for all execution results received from the application execution part 220.

After completing the creation of the intermediate files, a unique file name is generated in each of the intermediate files. Each of intermediate files is integrated, as file configuration information, with the unique identification value of the client issuing the print request, and is stored in the intermediate file management part 234. The file configuration information can be formed as a list file in which the file name of the created page image (intermediate file), the unique identification value, a job identification value, and the like are referred to. When the creation of the intermediate file is completed, the intermediate file creation part 232 sends the file configuration information such as the file name of the created intermediate file, with respect to the output data sending part 236 in order for the intermediate file management part 234 to read out the unique identification value of the client.

The output data sending part 236 accesses the intermediate file management part 234 by referring to the file configuration information. After reading the intermediate file and the unique identification value of the client, the output data sending part 236 sends the unique identification value of the client with respect to the destination control part 238. The destination control part 238 searches for the remote printer assigned to the unique identification value by looking up the correspondence table. In detail, after searching for configuration information to indicate the remote printer by referring to the correspondence table, the destination control part 238 acquires the print configuration information corresponding to the unique identification value as output destination printer information. After that, the destination control part 238 searches for a description location of data indicating a destination in data maintained by the output data sending part 236, and updates the destination by rewriting the destination written in at the searched description location with the acquired output destination printer information assigned to the unique identification value of the client.

The output data sending part 236 suspends its process until the destination control part 238 ends updating the destination. After the update of the destination ends, the output data sending part 236 calls the respective remote driver from the remote drivers 240, 242, 244, and 246, and has the respective remote driver execute a process of creating the RAW data from the intermediate file and a process of adding a PDL command. The output data are sent to the print server 120 via the network 130 through the spooler and the port monitor. The print server 120 sends the output data to the respective remote printer related to the received output data, and has the respective remote printer execute the print job. As a result, it is possible to create print material by the respective remote printer assigned to the client. Since the described destination control part 238 can be easily added to the printer network system 100, it is possible to implement the destination control part 238 as a plug-in program.

An implementation configuration of the virtual printer driver 230 illustrated in FIG. 2 is one of examples. The virtual printer driver 230 is not limited to the implementation configuration illustrated in FIG. 2 as long as another module configuration can provide the function of the virtual printer driver 230 according to the embodiment.

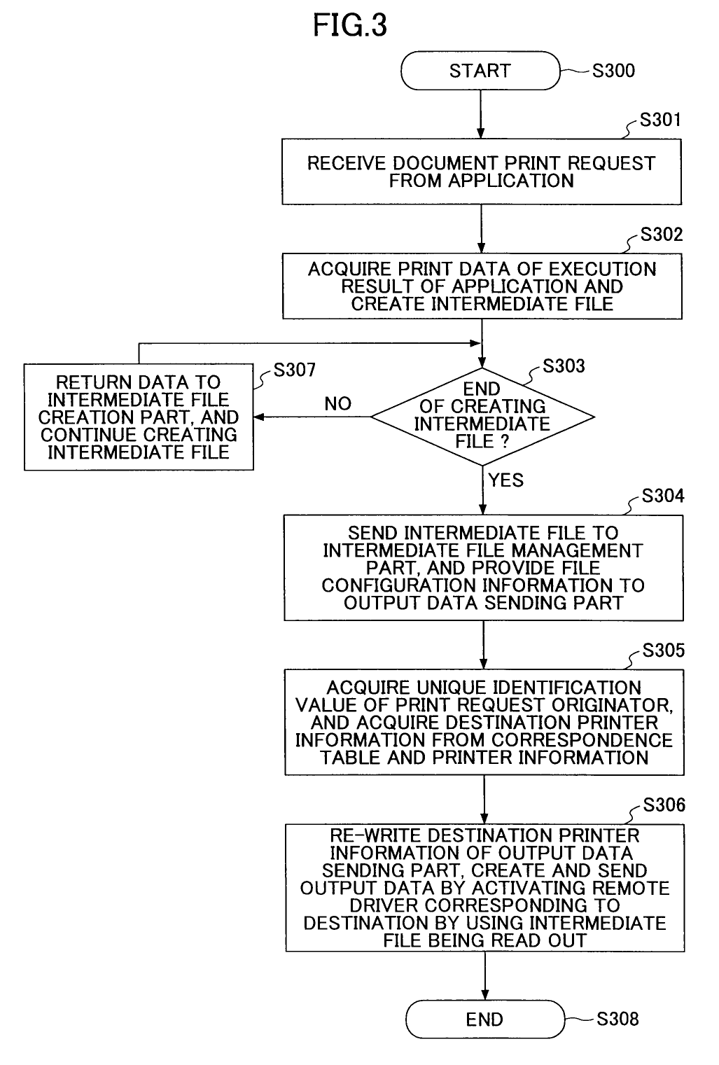

FIG. 3 is a flowchart of a process conducted by the data processing apparatus 110 according to the embodiment. The process illustrated in FIG. 3 starts from step S300. In step S301, the virtual printer driver 230 receives the print request with the execution result from each of the clients 112, 114, 116, and 118. In a case of the embodiment illustrated in FIG. 2, the execution result is created by the application execution part 220 in response to a request sent from each of the clients 112, 114, 116, and 118, and is sent to the virtual printer driver 230. In step S302, the virtual printer driver 230 acquires the execution result and starts creating the intermediate file. In step S303, it is determined whether or not the creation of the intermediate file ends based on whether or not each received execution result is converted into the intermediate file of the page image. In the step S303, when it is determined that the creation of the intermediate file is not completed (“no” of the step S303), the creation of the intermediate file is continued in step S307. The process of creating the intermediate file is repeated until it is determined that the creation of the intermediate file is completed in the step S303.

On the other hand, when it is determined that the creation of the intermediate file is completed (“yes” of the step S303), in step S304, the intermediate file creation part 232 provides a unique file name to the created intermediate file, and sends the created intermediate file with the unique identification value of the client or the user being a request originator, and a job identification value, to the intermediate file management part 234 to be stored into an intermediate file storage part thereof. Then, the intermediate file creation part 232 creates the file configuration information used to refer to various information items being stored, and the created file configuration information is buffered. After that, in step S304, the intermediate file creation part 232 reports the file configuration information to the output data sending part 236 to make it possible to read out the intermediate file and the unique identification value of the client.

In step S305, the destination control part 238 acquires the unique identification value of the print request originator from the output data sending part 236, and acquires the printer name from the correspondence table. Subsequently, the destination control part 238 uses the acquired printer name as a search key, refers to a printer information list in which configuration information of the remote printer in the network 130 is registered, and acquires the configuration information corresponding to the printer name as the output destination printer information.

After that, in step S306, the destination control part 238 rewrites data indicating a destination maintained by the output data sending part 236, with the output destination printer information, and resumes a process of the output data sending part 236. The output data sending part 236 activates a remote driver corresponding to an output destination printer, and has the remote driver conduct processes of adding a PDL command and creating the RAW data. The remote driver sends the created output data to the print server 120 through the spooler and the port monitor. The output data are sent to the remote printer corresponding to the remote driver, and are printed out by the remote printer. Then, the process by the data processing apparatus 110 is terminated in the step S308.

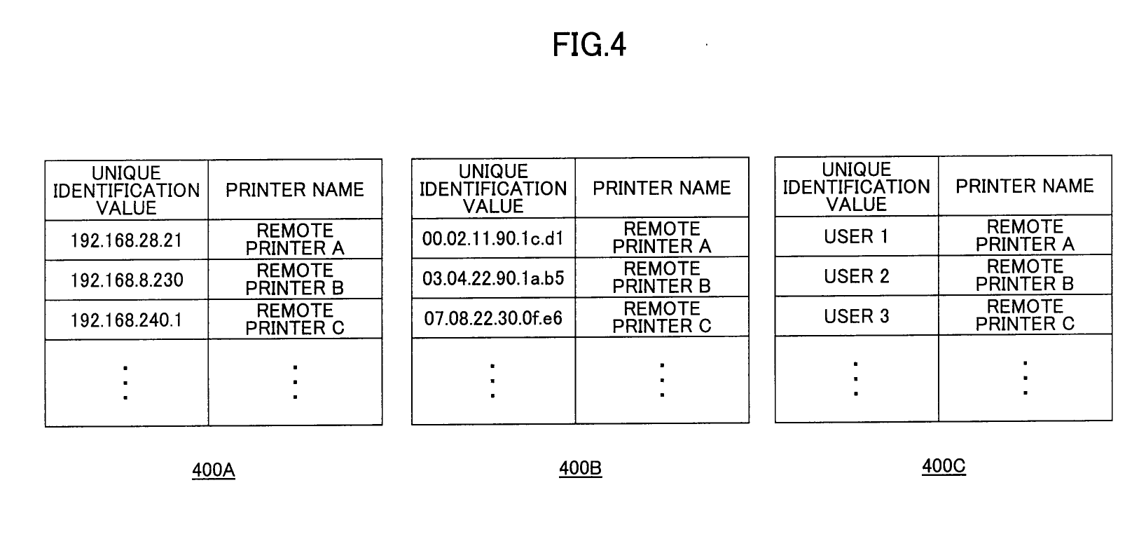

FIG. 4 illustrates examples of the correspondence table maintained by the destination control part 238. In a correspondence table 400A illustrated in FIG. 4, an IP address used as the unique identification value for each of the clients 112, 114, 116, and 118 is registered by corresponding to the printer name of a printer to which the IP address is assigned. It should be noted that the IP address may not be a unique number for one printer as illustrated in the correspondence table 400A, but the IP address can have an IP address range defined by a sub-net mask so as to correspond to a specific group.

In a correspondence table 400B, a MAC address is used as the unique identification value and corresponds to the printer name of the remote printer. In a correspondence table 400C, instead of a value identifying hardware such as the IP address, the MAC address, a client computer name, and the like, as the unique identification value, a unique value for a user of the client is used. For example, the remote printer name may be registered by corresponding to a login name of the user. The correspondence tables 400A and 400B can be preferably used in a case of assigning a specific remote printer with respect to a certain IP address range. The correspondence table 400C can be preferably used in a case of controlling an output destination for a user, instead of the clients 112, 114, 116, and 118.

In a case in that each of the clients 112, 114, 116, and 118 accesses the data processing apparatus 110, the data processing apparatus 110 acquires an IP address included in a packet for sending an access request, and uses the IP address registered in the correspondence table 400A illustrated in FIG. 4, for subsequent processes. Also, the data processing apparatus 110 acquires a MAC address of a sender of a packet for sending the access request, and uses the MAC address of the correspondence table 400B for subsequent processes. Furthermore, for example, an IC card is set as an access control device of the client when accessing the data processing apparatus 110, and a computer name and a user ID may be acquired as the unique identification value of the correspondence table 400C at the data processing apparatus 110 during an access authentication.

Alternatively, with respect to the clients 112, 114, 116, and 118 being connected to the network 130, the data processing apparatus 110 periodically broadcasts or multi-casts a PING. The data processing apparatus 110 registers the IP address of a sender replaying with an ICMP (Internet Control Message Protocol) response to a field of the unique identification value of the correspondence table 400A. As described above, the correspondence table 400A is created by assigning the remote printer name to the registered IP address.

In a case of using the correspondence table 400B, the data processing apparatus 110 acquires the MAC address by issuing an ARP (Address Resolution Protocol) command with respect to an IP address, and registers the acquired MAC address in a field of the unique identification value of the correspondence table 400B. The correspondence table 400B is created so that the remote printer name is assigned to the registered MAC address.

In a case of applying the correspondence table 400A, in order to support a lease of IP addresses such as a DHCP (Dynamic Host Configuration Protocol) server, the remote printer name may be set for each range of the IP addresses which the DHCP server can lease. Accordingly, the correspondence table 400A can be suitable for an IP address automatically assigned by the DHCP server.

In FIG. 4, regarding the correspondence table 400C, in a case of using the user ID as the unique identification value, an administrator collects user IDs and can register the user IDs by corresponding to respective remote printer names. Instead of exclusively implementing one of the correspondence tables 400A, 400B, and 400C illustrated in FIG. 4, all the correspondence tables 400A, 400B, and 400C can be implemented. In this case, in response to a specific purpose, one of the correspondence tables 400A, 400B, and 400C may be selected. Alternatively, a logical addition or a logical product of values among the correspondence tables 400A, 400B, and 400C may be used.

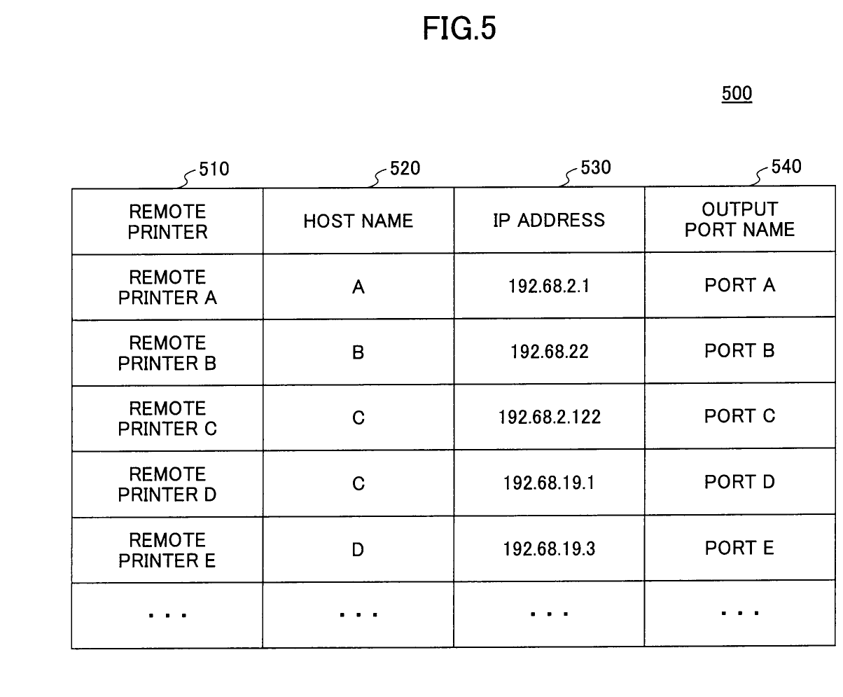

FIG. 5 illustrates an example of a printer information list 500 in which the configuration information of the remote printer, which the output data sending part 236 uses, is registered. The printer information list 500 illustrated in FIG. 5 is maintained by the destination control part 238 in this embodiment. In a case of leasing the remote driver corresponding to the remote printer from the print server 120, a record to register the configuration information of the remote printer can be automatically created and implemented in the printer information list 500. A field 510 is used to register the remote printer name. A field 520 is used to register host name given to an image forming apparatus, and a field 530 is used to register an IP address assigned to the image forming apparatus.

Moreover, a field 540 is used to register an output port name when the print data are sent to the image forming apparatus. For example, the host name is used when the image forming apparatus is searched by using a name resolution protocol such as a NETBEUI (NetBIOS Extended User Interface). The IP address is used when the print data are sent to the image forming apparatus by using the TCP/IP. The output port name is used as a handle or a pointer calling a device to which the print data are to be sent based on the registered IP address.

When receiving a notice of the unique identification value of an originator issuing the print request from the output data sending part 236, the destination control part 238 acquires the output destination printer information by looking up the print information list 500. After that, the destination management part 238 detects an area created by the output data sending part 236 in which, for example, the remote printer information of a DGDI (Graphic Device Interface) instance is described, and rewrites the remote printer information with acquired output destination printer information. Then, the destination management part 238 sends a notice of a rewrite end to the output data sending part 236.

The output data sending part 236 receives the notice of the rewrite end, and calls the remote driver corresponding to the rewritten value. The called remote driver adds a necessary PDL command in addition to conducting a conversion process converting into the RAW data of the intermediate file, and sends the print data to the print server 120 by calling the spooler and the port monitor.

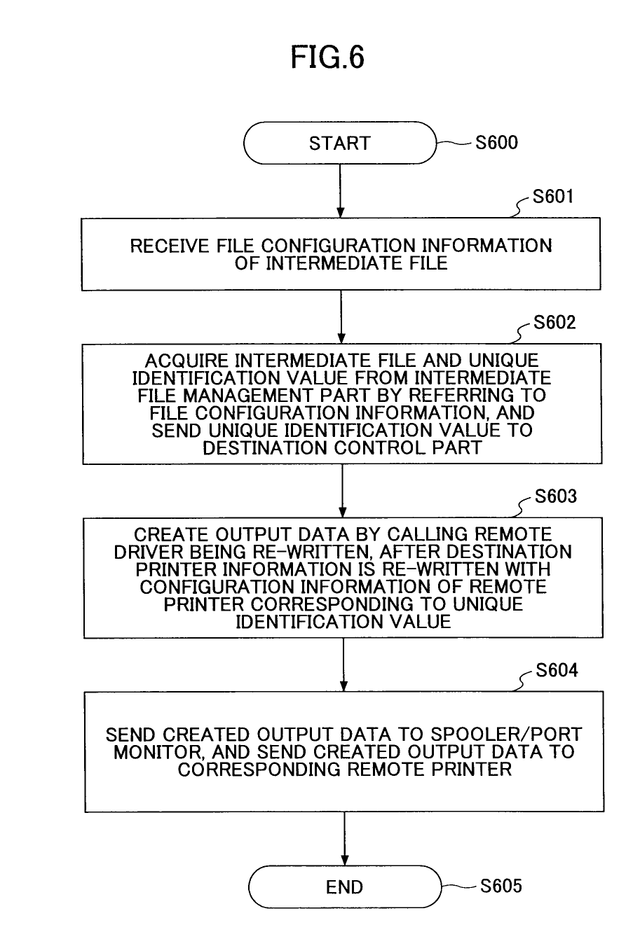

FIG. 6 illustrates a flowchart of a process conducted by the output data sending part 236. The process starts from step S600 in which the vertical printer driver 230 is called. In step S601, the output data sending part 236 receives the file configuration information of the internal file from the intermediate file creation part 232. The file configuration information includes information for reading out the file name specific to the created intermediate file, the unique identification value of the client or the user, a job identification value, and the like. In step S602, the output data sending part 236 reads out the intermediate file and the unique identification value from the intermediate file management part 234 by referring to storage information of the file configuration information, and sends the unique identification value to the destination control part 238.

It should be noted that a value of a dummy printer which is not actually connected is set as the output destination printer information of a default setting. As a result, the virtual printer driver 230 fails calling the respective remote driver at the beginning. However, in this embodiment, even if the virtual printer driver 230 fails calling the respective remote driver, the virtual printer driver 230 waits until a predetermined time-out term lapses and retains a print instance until the respective remote driver is successfully called.

In an alternative procedure, the destination control part 238 which will be described later sends the notice to the output data sending part 236 by an inter-process communication when the rewrite of the output destination printer information ends. Accordingly, the process of the output data sending part 236 can be resumed. Moreover, in a DEVMODE structure used when the virtual printer driver 230 generates a specific print instance, a setting value corresponding to a device type of the highest level in connected remote printers is selected, so as to provide the print process corresponding to the device type of the highest level in the connected remote printers. In this case, the remote printer being a device type of a lower level skips functions which are not implemented therein, creates the RAW data specific to the device type, and adds the PDL command.

In step S603, when the output destination printer information is rewritten with the configuration information of the remote printer corresponding to the unique identification value, the output data sending part 236 creates the output data by calling the rewritten remote driver. In this case, the process of adding the PDL command can also conducted. After that, in step S604, the output data sending part 236 sends the output data, which are created to address to the respective remote printer, to the spooler and the port monitor. In step s605, the output data sending part 236 terminates this process.

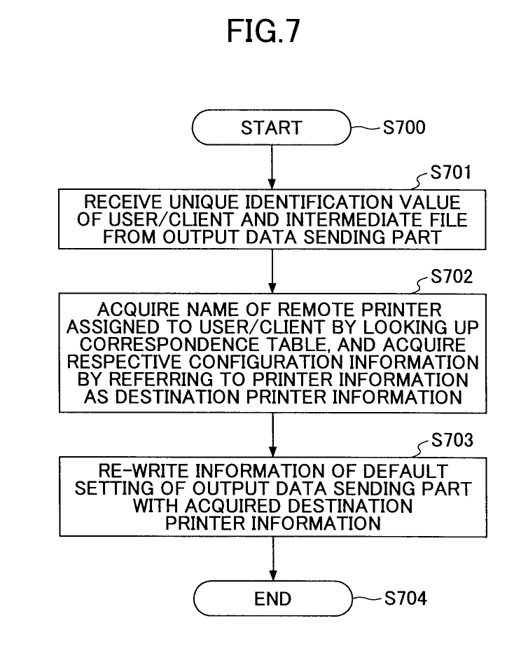

FIG. 7 is a flowchart of the process conducted by the destination control part 238. The process in FIG. 7 starts from step S700, and receives the unique identification value of the user or the client from the output data sending part 236 in step S701. In step S702, the destination control part 238 looks up one or more of the correspondence tables 400A, 400B, and 400C, and acquires the printer name of the remote printer assigned to the user or the client. After that, the destination control part 238 looks up the printer information list 500 by using the printer name as a search key, and acquires the configuration information of the printer name corresponding to the printer name as the output destination printer information.

In step S703, the output destination printer information of the output data sending part 236 is rewritten with the acquired remote printer information. After the rewriting the output destination printer information ends, the destination control part 238 normally terminates the process in step S704. Alternatively, in the step S704, the destination control part 238 sends a notice to the output data sending part 236 by using the inter-process communication to explicitly indicate a process start, and terminates this process.

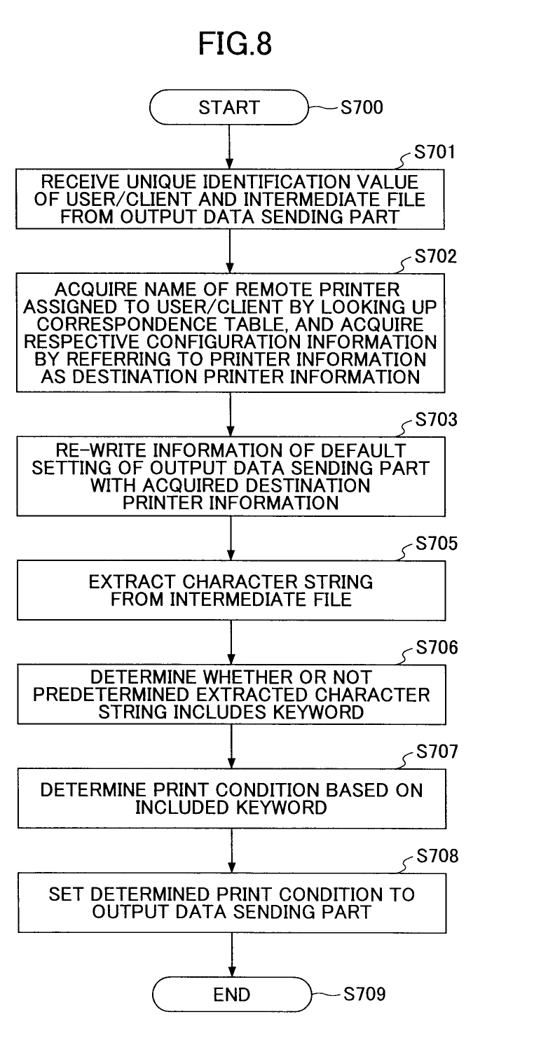

Next, a modification of the process conducted by the destination control part 238 will be described. FIG. 8 is a flowchart of a modified example of the process conducted by the destination control part 238. In FIG. 8, steps that are the same as those illustrated in FIG. 7 are given the same reference numbers, and explanations thereof will be omitted.

In the modified example, in step S701, the destination control part 238 receives the intermediate file with the unique identification value of the user or the client. Then, the destination control part 238 proceeds to steps S702, S703, and S704 as previously described. After that, in step S705, the destination control part 238 extracts a character string (text data) included in the intermediate file. In a case in that the intermediate file is image data, an OCR (Optical Character Recognition) technology may be used to extract the character string. In step S706, the destination control part 238 determines whether or not a predetermined keyword is included in the extracted character string. For example, the predetermined keyword is registered in a print condition management table 238-2 managed by the destination control part 238.

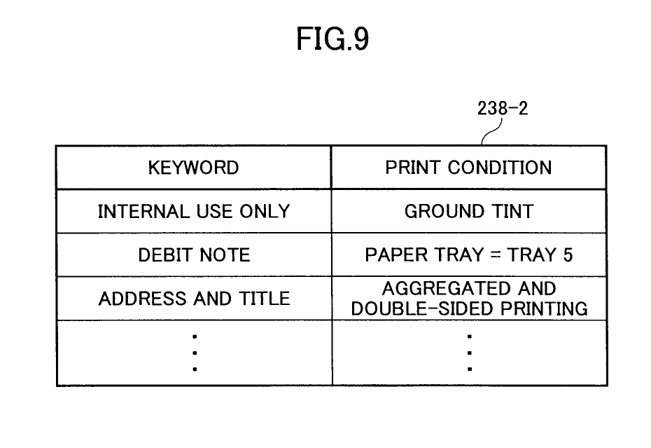

FIG. 9 is a diagram illustrating an example of the print condition management table 238-2. In FIG. 9, a print condition is registered for each keyword in the print condition management table 238-2. In FIG. 9, “INTERNAL USE ONLY”, “DEBIT NOTE”, “ADDRESS AND TITLE”, and the like are given as examples of keywords. Regarding the keyword “ADDRESS AND TITLE”, it should be noted that if both words “ADDRESS” and “TITLE” are included, it is determined that the keyword “ADDRESS AND TITLE” is included.

In step S707, the print condition is determined based on the keyword included in the extracted character string. That is, the print condition corresponding to the keyword is determined by referring to the print condition management table 238-2. Accordingly, referring to the print condition management table 238-2 in FIG. 9, if the keyword “INTERNAL USE ONLY” is included, it is determined that a ground tint is valid. If the keyword “DEBIT NOTE” is included, it is determined that a tray 5 is used as a paper tray. If the keyword “ADDRESS AND TITLE” is included, it is determined that an aggregated and double-sided printing is conducted.

In step S708, the destination control part 238 sets the determined print condition in the output data sending part 236. When the print condition is set in the output data sending part 236, the output data sending part 236 sets the print condition to the remote driver. After that, the output data sending part 236 causes the remote driver to conduct processes of creating the RAW data and adding the PDL command. Therefore, information indicating the print condition is included in the RAW data or the PDL command.

As a result, a print job based on the output data provided from the remote driver is conducted to output in accordance with the print condition. In step S709, the destination control part 238 terminates this process.

In the modified example, the print condition can be automatically changed in accordance with the character string included in the print data. In a case in that an operation of “print cancel” can be indicated as the print condition and if a keyword corresponding to this print condition is included, a print may be cancelled. Alternatively, it may be possible to indicate the printer name of the remote printer being the output destination, as the print condition. If the keyword corresponding to the print condition is included, the destination control part 238 may acquire the configuration information corresponding to the print name indicated by the print condition from the print information list 500, and may set the acquired configuration information as the output destination printer information. Accordingly, it is possible to change the output destination in accordance with the character string included in the print data.

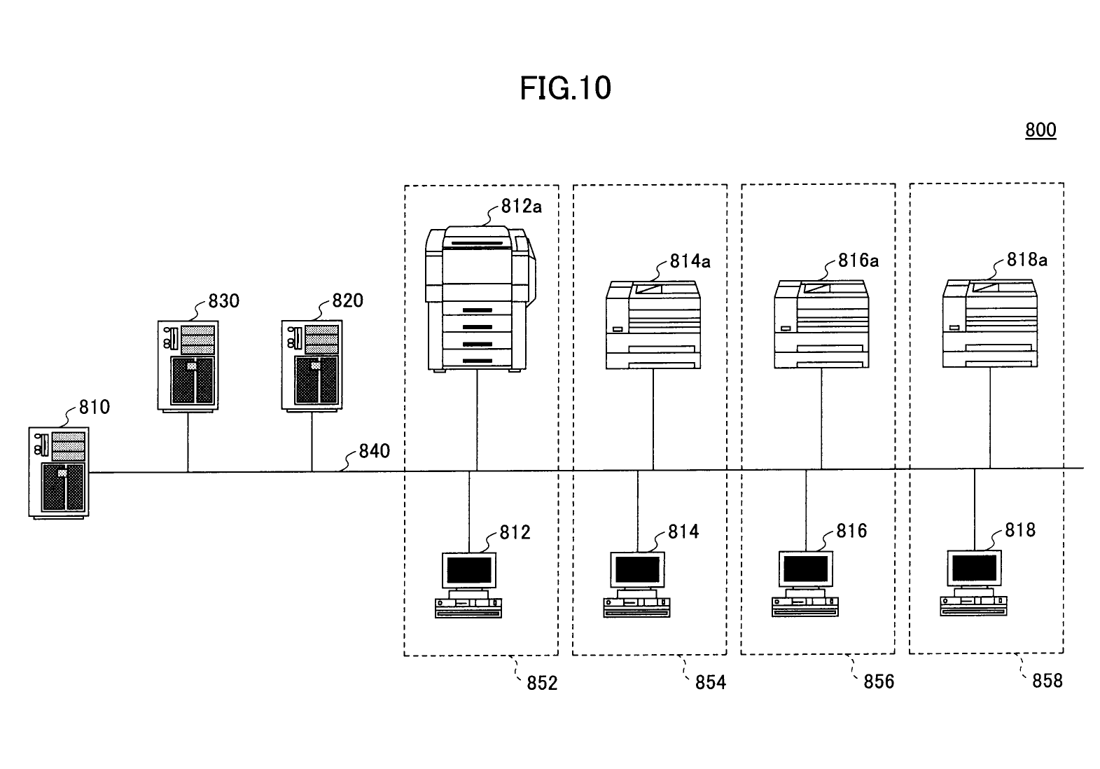

FIG. 10 illustrates a printer network 800 according to a second embodiment of the present invention. The printer network 800 includes an application server 810 connected to a network 840. The application server 810 mostly processes an application service request from each of a plurality of clients 812, 814, 816, and 818 connected to the network 840, and conducts a process for returning a process result to a request originator.

In the second embodiment in FIG. 10, the clients 812, 814, 816, and 818 may be thin clients or may be fat clients, and are not limited to either one of the thin clients and the fat clients. For example, the application server 810 illustrated in FIG. 10 can be a business server or a Web server. The application server 810 receives the print request from each of the clients 812, 814, 816, and 818 when a process by the application ends.

When receiving the print request, for example, the application server 810 sends an execution result of the application server 810 to a data processing server 820 by using a network communication protocol such as an FTP (File Transfer Protocol), an HTTP (HyperText Transfer Protocol), a socket, and the like. The data processing server 820 includes functions of the data processing apparatus 110 of the first embodiment. When receiving the login name of the user of the client sending the execution result and the print request from the application server 810, the data processing server 820 generates a print session.

At a time when the print session is generated, the data processing server 820 requests the application server 810 to send the unique identification value of the client which is activated with the login name by using the login name as the search key. In this case, the unique identification value is maintained by the application server 810 as a session management table in which the unique identification value corresponds to the login name. When the application server 810 acquires the unique identification value corresponding to the login name by using the login name as the search key, the application server 810 sends back the acquired unique identification value as a response to the data processing server 820. As the unique identification value, the IP address, the MAC address, the computer name, or the like illustrated in FIG. 4 can be used.

A print server 830 is connected to the network 840, and controls and manages remote printers 812a, 814a, 816a, and 818a connected to the print server 830 similarly to the first embodiment. In the second embodiment explained with reference to FIG. 10, the remote printer 812a processes the print request from the client 812. The clients 814, 816, and 818 are controlled to output to the remote printers 814a, 816a, and 818a, respectively. The clients 812, 814, 816, and 818 and the respective remote printers 812a, 814a, 816a, and 818a are dependently formed bases 852, 854, 856, and 858, respectively. Similar to the first embodiment in FIG. 1, a plurality of clients may be in each of the bases 852, 854, 856, and 858. In the same manner, a plurality of remote printers may be in each of the bases 852, 854, 856, and 858.

Alternatively, instead of sending the login name to the application server 810, a session ID of the generated print session is sent to the application server 810, and the client or the login name requesting the print session is searched for by using the session ID as the search key, so that the IP address, the MAC address, the computer name, and the like are acquired.

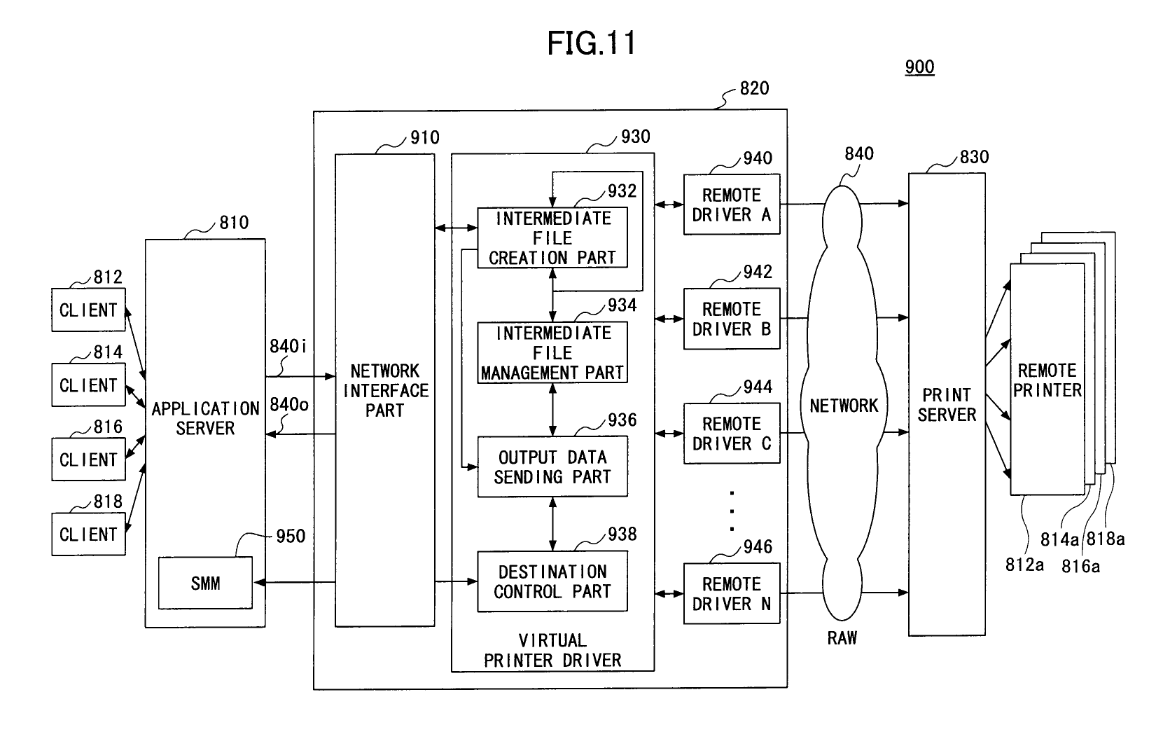

FIG. 11 illustrates a function block 900 of the data processing server 820 according to the second embodiment. Different from the data processing apparatus 110 illustrated in FIG. 2, in the data processing server 820, an application execution part 220 is separated as the application server 810 and a destination control part 938 includes different functions. Other functions in the data processing server 820 are generally the same as the data processing apparatus 110.

The data processing server 820 receives data (as input network data 840i) from the application server 810 and sends data (as output network data 840o) to the application server 810. The data processing server 820 receives the print request and the execution result from the application server 810, and extracts the login name of the user included in the print request. After that, the data processing server 820 calls a virtual printer driver 930, and creates the page image as the intermediate file from the execution result by using an intermediate file creation part 932. After creating the intermediate file is completed, the data processing server 820 stores the file name and the login name specific to the intermediate file in an intermediate file management part 934. After that, the intermediate file creation part 932 sends the file configuration information including the file name and the login name of the intermediate file to an output data sending part 936.

When the output data sending part 936 receives the file configuration information including the file name and the login name, the output data sending part 936 sends the login name to the destination control part 938. When the destination control part 938 receives the login name, the destination control part 938 issues a query with respect to a session management module (SMM) 950 of the application server 810, and acquires information including the unique identification value such as the IP address, the MAC address, the computer name, or the like of one of the clients 812, 814, 816, and 818 which is identified by the login name, and also including the print data. In the second embodiment, the session management module 950 is not implemented simply to be dedicated to this purpose. The session management module 950 can be implemented to open a job content indicated by the session name, to the data processing apparatus 820 by using the FTP and a SNMP (Simple Network Management Protocol). For example, the job content may be opened to the data processing apparatus 820 by copying it to a download file, an MIB (Management Information Base), or the like.

After that, the destination control part 938 refers to the acquired unique identification value, determines the remote printer name by using one or more of the correspondence tables 400A, 400B, and 400C, and further acquires the output destination printer information by referring to the printer information list 500. After that, the destination control part 938 rewrites the output destination printer information of a default setting which the output data sending part 936 maintains at this point, with the acquired output destination printer information. The destination control part 938 informs the output data sending part 936 of a rewrite end. After receiving the rewrite end, the output data sending part 936 calls one of the remote drivers 940, 942, 944, and 946 which is indicated to have it create the RAW data from the intermediate file and execute an addition process of the PDL command, then sends the output data to the print server 830 through the spooler and the port monitor. Therefore, it is possible to print out at the indicated remote printer.

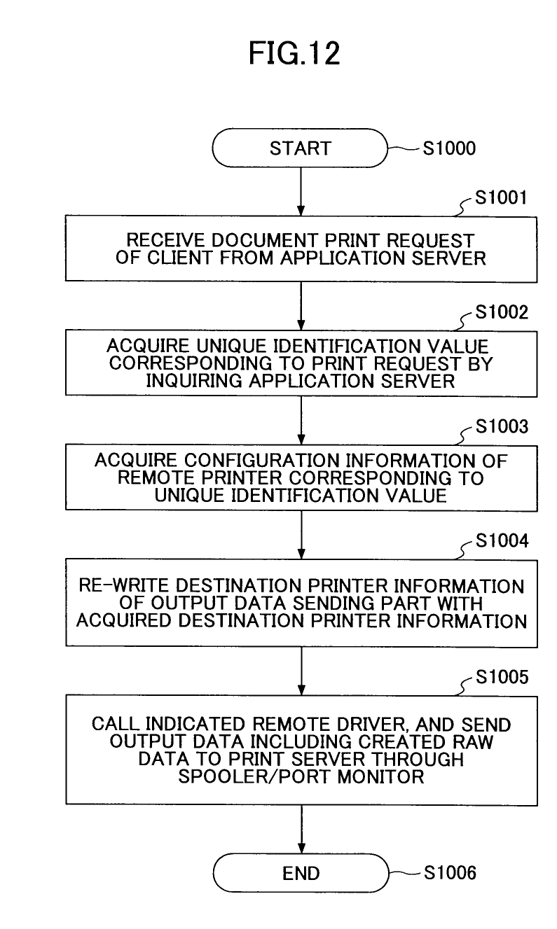

FIG. 12 illustrates a flowchart of a destination control process conducted by the data processing server 820. The data processing server 820 starts a process in FIG. 12 when a connection request is received from the application server 810 at step S1000, and receives a print request of the thin client from the application server 810 in step S1001. In step S1002, the data processing server 820 queries the application server 810 by using the login name included in the print request, and acquires the unique identification value of the client from the application server 810. In step S1003, the data processing server 820 acquires the IP address, the MAC address, and the like corresponding to the unique identification value.

After that, in step S1004, the data processing server 820 acquires the output destination printer information by looking up one or more of the correspondence tables 400A, 400B, and 400C and the output destination printer list 500 by using the acquired unique identification value as the search key. After that, the data processing server 820 rewrites the output destination printer information of the output data sending part 936 with the acquired output destination printer information. At an end of rewriting the output destination printer information, the data processing server 820 informs the output data sending part 936 of the rewrite end. In step S1005, the output data sending part 936 calls the indicated remote driver, and adds the PDL command to the RAW data created by the indicated remote driver. After the output data are sent to the print server 830 through the spooler and the port monitor, the data processing server 820 terminates this process in step S1006, and waits for a next print request.

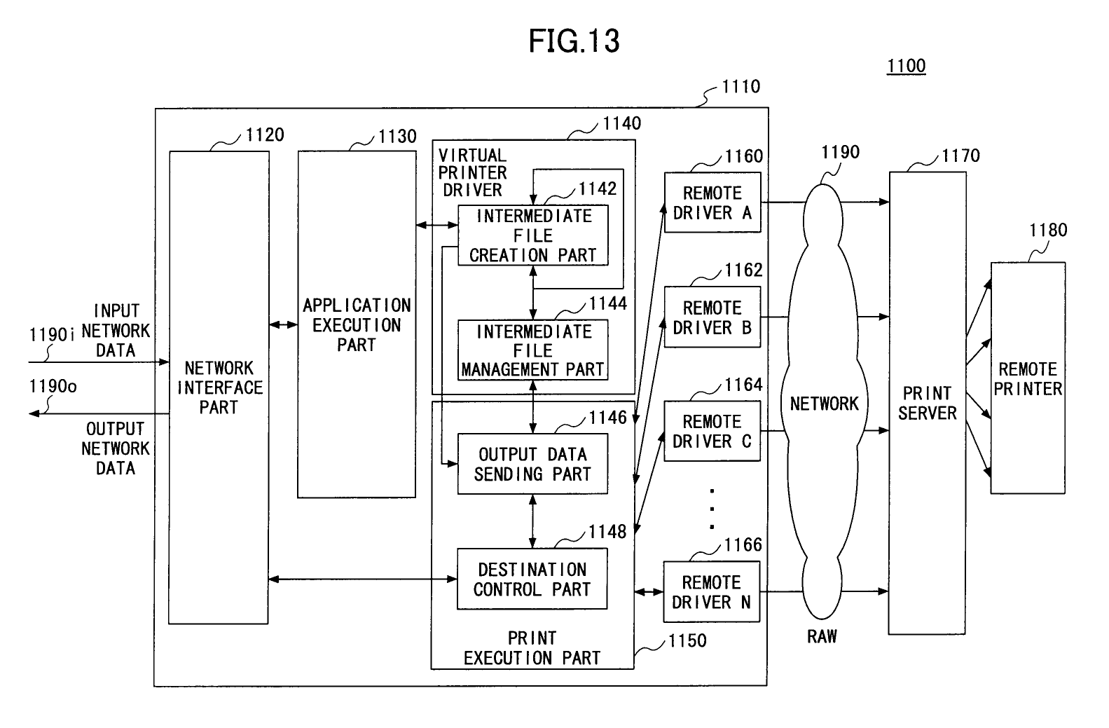

FIG. 13 illustrates another function block 1100 of a data processing server 1110. As illustrated in FIG. 13, the data processing apparatus 1110 includes a network interface part 1120 and an application execution part 1130. The network interface part 1120 receives data (as input network data 1190i) in accordance with TCP/IP through a network 1190, and outputs a process result (as output network data 11900) of the application execution part 220 through the network 1190. In the function block 1100 illustrate in FIG. 13, different from the function block 200 in FIG. 2 and the function block 900 in FIG. 11, the virtual printer driver 230 or 930 is functionally divided into a virtual printer driver 1140 and a print execution part 1150. Other functions in the data processing apparatus 1110 are generally the same as the data processing apparatus 110 in FIG. 2 and the data processing server 820 in FIG. 11, and explanation thereof will be omitted. Functions of the virtual printer driver 1140 and the print execution part 1150 will be explained in detail.

The virtual printer driver 1140 includes an intermediate file creation part 1142 and an intermediate file management part 1144. The virtual printer driver 1140 mainly creates the intermediate file and the file configuration information, and sends the file configuration information to the print execution part 1150. The print execution part 1150 includes an output data sending part 1146 and a destination control part 1148. The output data sending part 1146 extracts the intermediate file from the intermediate file management part 1144 in accordance with the file configuration information. The destination control part 1148 acquires the unique identification value of the client included in the print request, and selects the destination. In another embodiment in which the data processing apparatus 1110 does not include the application execution part 1130 and is separately configured as another information processing apparatus, the data processing apparatus 1110 sends a query about an individual identification value to a session management module (SMM) included in an application server being remotely provided, acquires the individual identification value, and selects the destination.

After that, the destination control part 1148 rewrites the output destination printer information of the default setting which is maintained by the output data sending part 1146 at this point, with the acquired output destination printer information, and reports a rewrite end to the output data sending part 1146. After receiving the rewrite end, the output data sending part 1146 calls one of remote drivers 1160, 1162, 1164, 1166 which is indicated. The called remote driver creates the RAW data from the intermediate file, adds the PDL command, and sends the output data to the print server 1170 via the network 1190 through the spooler and the port monitor. The output data are sent to a remote printer 1180 through the network 1190 by a printer driver of the print server 1170.

In the function block 1100 illustrated in FIG. 13, in a case in that a plurality of clients send a large amount of print jobs to the virtual printer driver 1140, even if a specific remote driver stops due to an error, other jobs can be prevented from being influenced. Thus, it is possible to improve robustness of a printer network system.

As described above, according to the present invention, in a network print environment where it is possible for a personal computer and a thin client to access to a plurality of image forming apparatuses, it is possible to provide a data processing apparatus, a printer network system, a data processing method, a program product, and a computer-readable recording medium, in which a client computer connected through a network can always output to the same printer, management for each output business transaction can be effective, and information security can be improved. Moreover, according to the present invention, instead of adding an application module to an application server, it is possible to provide a data processing apparatus, a printer network system, a data processing method, a program product, and a computer-readable recording medium, in which an output destination can be controlled at minimum expense.

Moreover, according to the present invention, it is possible to provide a data processing apparatus, a printer network system, a data processing method, a program product, and a computer-readable recording medium, in which an additional installation of a printer driver of a remote printer for a thin client is excluded, and output destination management of a print output can be made in response to a more flexible network configuration.

The above-described functions can be realize by a computer program which is written in an object-oriented programming language such as C, C++, C#, Java, and the like. A program according to the present invention can be distributed by being stored in a computer-readable recording medium such as a hard disk unit, a CD-ROM (Compact Disk Read Only Memory), an MO (Magneto-Optical disk), a flexible disk, an EEPROM (Electrically Erasable and Programmable Read Only Memory), an EPROM (Erasable Programmable Read Only Memory), and the like, and can be transmitted through a network.

Accordingly, a substantive modification is not required to a server program, but it is possible to control an output in response to a print request sent from one or more clients which are managed by a business transaction server with respect to a plurality of printers by associating a user, a client computer, or a group thereof.

As described above, a data processing method conducted by a processor functioning as a data processing apparatus which manages print outputs of one or more client computers through a network, may include a step causing the processor to receive a print request through the network; a step causing the processor to create an intermediate file as a page image from print data corresponding to the print request; a step causing the processor to select and call a remote driver from a plurality of remote drivers so that the remote driver corresponds to output destination printer information selected for a remote printer corresponding to the client computer or a user by using the intermediate file; and a step causing the processor to create output data by calling the remote driver, and to cause the remote printer to output the output data.

In the data processing method, the step causing the processor to create the intermediate file further includes a step causing the processor to register a file name of the created intermediate file by corresponding to a unique identification value for uniquely identifying an originator of the print request, and the step causing the processor to select and call the remote driver from a plurality of remote drivers includes: a step causing the processor to receive file configuration information including information for referring to the file name and the unique identification value, and to read out the intermediate file and the unique identification value; and a step causing the processor to acquire configuration information of a remote printer corresponded to the unique identification value as output destination printer information, and to rewrite a value of a default setting set as an output destination of the print data with the output destination printer information.

In the data processing method, the step causing the processor to cause the remote printer to output the output data includes a step causing the processor to wait for creating the output data until a notice of an end of rewriting the output destination printer information is received.

Therefore, according to the present invention, it is possible to properly control an output destination of print data from a client computer.

The present invention is not limited to the specifically disclosed embodiments, and variations and modifications may be made without departing from the scope of the invention.

The present application is based on Japanese Priority Patent Applications No. 2008-307495 filed on Dec. 2, 2008, and No. 2009-229846 filed on Oct. 1, 2009 the entire contents of which are hereby incorporated by reference.

What is claimed is:

1. A data processing apparatus for managing print outputs for one or more client computers through a network, comprising:
a virtual printer driver configured to receive a print request through the network, to create an intermediate file as a page image from print data corresponding to the print request, to have a remote driver corresponding to output destination printer information corresponding to the client computer or a user of the client computer create output data for a remote printer, and to have the remote printer output the output data; and
a plurality of remote drivers each of which is configured to be called by the virtual printer driver, to create the output data including RAW data from the intermediate file, and to cause the remote printer selected through the network to print out the output data.

2. The data processing apparatus as claimed in claim 1, wherein the virtual printer driver comprises:
an intermediate file creation part configured to receive the print data, to create the intermediate file, to receive file configuration information in which a file name of the intermediate file corresponds to a unique identification value for uniquely identifying an originator of the print request, and to register the file configuration information in an intermediate file management part;
an output data sending part configured to receive the file configuration information, and to read out the intermediate file and the unique identification value from the intermediate file management part; and
a destination control part configured to receive the unique identification value from the output data sending part, to acquire configuration information of a remote printer corresponding to the unique identification value as the output destination printer information, and to rewrite a value of a default setting of the output data sending part with the output destination printer information.

3. The data processing apparatus as claimed in claim 1, wherein the data processing apparatus has the output data sending part wait for creating the output data until a notice of an end of rewriting the output destination printer information is received from the destination control part.

4. The data processing apparatus as claimed in claim 2, wherein the destination control part is configured to maintain a correspondence table in which the unique identification value corresponds to a printer name of the remote printer, and a printer information list in which the configuration information of the remote printer including the printer name is registered, and to select the output destination printer information by acquiring the unique identification value and referring to the correspondence table and the printer information list.

5. The data processing apparatus as claimed in claim 1, wherein the unique identification value is an IP address, a MAC address, a computer name, information included in the print data, or a login name.

6. A printer network system, comprising:
a client computer connected through a network;
a data processing apparatus configured to receive a print request from the client computer, to create output data, and to send the output data through the network; and
a print server configured to have a remote printer indicated by a unique identification value for uniquely identifying the client computer or a user output the output data from the data processing apparatus,
wherein the data processing apparatus includes:
a virtual printer driver configured to receive the print request through the network, to create an intermediate file as a page image from print data corresponding to the print request, to have a remote driver corresponding to output destination printer information corresponding to the client computer or a user of the client computer create output data for a remote printer, and to cause the remote printer to output the output data; and
a plurality of remote drivers each of which is configured to be called by the virtual printer driver, to create the output data including RAW data from the intermediate file, and to cause the remote printer selected through the network to print out the output data.

7. The printer network system as claimed in claim 6, wherein the client computer is a thin client or a fat client.

8. A computer-readable recording medium encoded with a computer program that causes a computer to execute a method of managing print outputs of one or more client computers through a network, the method comprising:
receiving a print request through the network;
creating an intermediate file as a page image from print data corresponding to the print request;
selecting and calling a remote driver from a plurality of remote drivers so that the remote driver corresponds to output destination printer information selected for a remote printer corresponding to the client computer or a user by using an intermediate file; and
creating output data by the remote driver being called, and having the remote printer output the output data.
